(19) United States
(12) Patent Application Publication
(10) Pub. No.: US 2025/0256404 A1
(43) Pub. Date: Aug. 14, 2025

(54) CONTROL DEVICE, ROBOT SYSTEM, OBJECT PRESENCE/ABSENCE DETERMINATION METHOD, AND PROGRAM

(71) Applicant: FANUC CORPORATION, Yamanashi (JP)

(72) Inventors: Misaki Ito, Yamanashi (JP); Yuta Namiki, Yamanashi (JP)

(21) Appl. No.: 19/194,591

(22) Filed: Apr. 30, 2025

Related U.S. Application Data
(63) Continuation of application No. PCT/JP2022/047928, filed on Dec. 26, 2022.

(51) Int. Cl. B25J 9/16; B25J 13/08; B25J 19/02

(52) U.S. Cl. CPC B25J 9/1697; B25J 9/161; B25J 13/08; B25J 19/023

(57) ABSTRACT

A control device comprising an image acquisition unit which acquires a distance image captured by a visual sensor; and a determination unit which, on the basis of the distance image, determines whether or not an object has been placed within a range specified by predetermined input information.

### CROSS-REFERENCE TO RELATED APPLICATIONS

This application is a bypass continuation application of International Application No. PCT/JP2022/047928 filed Dec. 26, 2022.

### BACKGROUND

### Field

The present disclosure relates to a controller of an industrial robot, a robot system, an object presence determination method, and a program.

### Discussion of the Related Art

A robot system executing workpiece pickup work of picking up, by a robot, workpieces (e.g., workpieces loaded in bulk) placed at undefined positions by detecting the workpieces by a visual sensor, and arranging the workpieces on a worktable, a conveying device, or the like is known.

For example, PTL 1 describes a handling system for workpiece transfer used when applying grinder finishing to a plate-like metal workpiece acquired by fusion cutting or the like.

PTL 2 describes a surveillance device included in a robot system performing predetermined work on a workpiece. The surveillance device includes a three-dimensional camera and determines whether an object is present in a restricted region, based on the distances from the camera to a plurality of measurement points set on the surface of the workpiece.

For example, in a robot system performing handling of workpieces such as pickup and transfer of workpieces, a situation in which, due to some cause, a workpiece placed by a robot in a preceding operation remains present at a location where another workpiece is to be placed by the robot may occur. When such a situation occurs, a malfunction (such as suspension of a production cycle) may occur in the robot system due to mutual interference between workpieces when the robot attempts to place a workpiece.

A technology enabling detection of whether an object is present at an inspection target location and thereby reliably enabling detection of a malfunction in handling work of workpieces by the robot and prevention of occurrence of such a malfunction is desired.

### SUMMARY

An embodiment of the present disclosure is a controller including an image acquisition unit acquiring a depth map captured by a visual sensor and a determination unit determining whether an object is placed within a range specified by predetermined input information, based on the depth map.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system including a robot controller according to an embodiment.

FIG. 2 is a functional block diagram of the robot controller and a visual sensor control unit.

FIG. 3 is a diagram for illustrating a depth map acquired by a three-dimensional camera.

FIG. 4 is a diagram for illustrating a first example of a search range setting function provided by a search range setting unit.

FIG. 5 is a diagram for illustrating a second example of the search range setting function provided by the search range setting unit.

FIG. 6 is a diagram for illustrating a third example of the search range setting function provided by the search range setting unit.

FIG. 7 is a diagram for illustrating a fourth example of the search range setting function provided by the search range setting unit.

FIG. 8 is a diagram for illustrating an image capture range and a search range.

FIG. 9 is a diagram illustrating a histogram for a first search range illustrated in FIG. 8.

FIG. 10 is a diagram illustrating a histogram for a second search range illustrated in FIG. 8.

FIG. 11 is a flowchart in a case of generally expressing an object presence determination function executed by the robot controller.

FIG. 12 is a flowchart illustrating a specific operation of object presence determination processing executed by the robot controller.

FIG. 13 is a flowchart in a case of applying the object presence determination processing to workpiece transfer processing.

FIG. 14 is a diagram illustrating a state in which a visual sensor captures a depth map in a situation in which nothing is placed on a placement surface, and a histogram of the depth map acquired at that time.

FIG. 15 is a diagram illustrating a state of the visual sensor capturing a depth map in a state in which a workpiece is placed on the placement surface, and a histogram of the depth map acquired at that time.

FIG. 16 is a diagram illustrating an example of a graphical user interface for setting a threshold value.

FIG. 17 is a flowchart in a case of applying the object presence determination processing to pickup processing of workpieces loaded in bulk.

FIG. 18 is a diagram illustrating a situation in which the visual sensor captures a depth map in a state in which many workpieces are present in a container, and a histogram of the depth map acquired at that time.

FIG. 19 is a diagram illustrating a situation in which the visual sensor captures a depth map in a state in which no object is present in the container, and a histogram of the depth map acquired at that time.

FIG. 20 is a diagram illustrating a situation in which the visual sensor captures a depth map in a state in which one workpiece remains in the container, and a histogram of the depth map acquired at that time.

### DETAILED DESCRIPTION OF THE EMBODIMENTS

Next, embodiments of the present disclosure will be described with reference to the drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

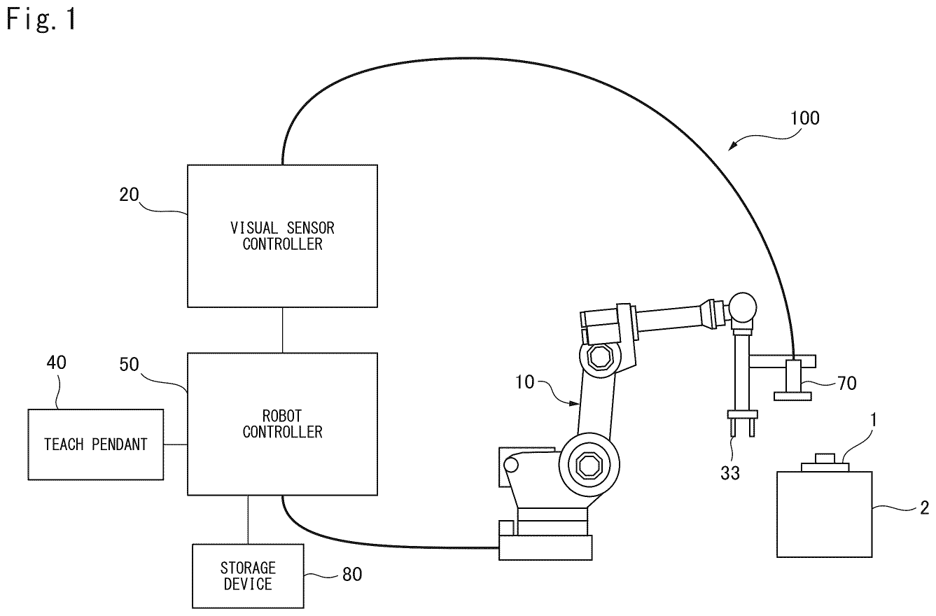

FIG. 1 is a diagram illustrating a configuration of robot system 100 including robot controller 50 according to an embodiment. As illustrated in FIG. 1, robot system 100 includes robot 10 equipped with hand 33 on the arm tip, robot controller 50 controlling robot 10, teach pendant 40 connected to robot controller 50, visual sensor 70 attached to the arm tip of robot 10, and visual sensor controller 20 controlling visual sensor 70. For example, robot system 100 can perform detection of target object 1 on worktable 2 by visual sensor 70 and handling of target object 1 with hand 33 mounted on robot 10. Robot system 100 is further configured to be able to determine whether an object is placed within a range specified by predetermined input information, based on a depth map captured by visual sensor 70.

Robot system 100 may further include storage device 80 for storing execution history data and other information. For example, storage device 80 is an external memory connected to robot controller 50. Alternatively, storage device 80 may be a storage, an external computer, or the like connected to robot controller 50 through a network. It should be noted that, while FIG. 1 illustrates a configuration in which robot system 100 includes an independent device as storage device 80, the function as storage device 80 may be provided in robot controller 50 or teach pendant 40. A configuration of the storage device 80 being connected to the teach pendant 40 is a possible example.

While robot 10 is a vertical articulated robot in the present embodiment, another type of robot such as a parallel link robot or a dual-arm robot may be used depending on the purpose of the work. Robot 10 can execute desired work with an end effector attached to the wrist. FIG. 1 illustrates an example of using hand 33 as an end effector.

It is assumed that visual sensor 70 has a function as a two-dimensional camera capturing a gray image or a color image, and a function as a three-dimensional camera acquiring a depth map. A plurality of visual sensors may be arranged in robot system 100. For example, a time-of-flight (TOF) camera capturing a depth map by a time-of-flight method or a stereo camera including two cameras may be used as the three-dimensional camera. It should be noted that, while FIG. 1 illustrates a configuration example of mounting visual sensor 70 on robot 10, visual sensor 70 may be a fixed camera fixed to a workspace.

Visual sensor controller 20 holds a model pattern of a target object and can execute image processing of detecting the target object by pattern matching between an image of the target object in a captured image and the model pattern. It is assumed that visual sensor 70 is calibrated and visual sensor controller 20 holds calibration data defining a relative positional relation between visual sensor 70 and robot 10. Thus, a position in a two-dimensional image captured by visual sensor 70 can be transformed into a position in a coordinate system fixed to the workspace (e.g., a robot coordinate system).

While visual sensor controller 20 is configured to be a device separately provided from robot controller 50 in FIG. 1, the function as visual sensor controller 20 may be embedded in robot controller 50.

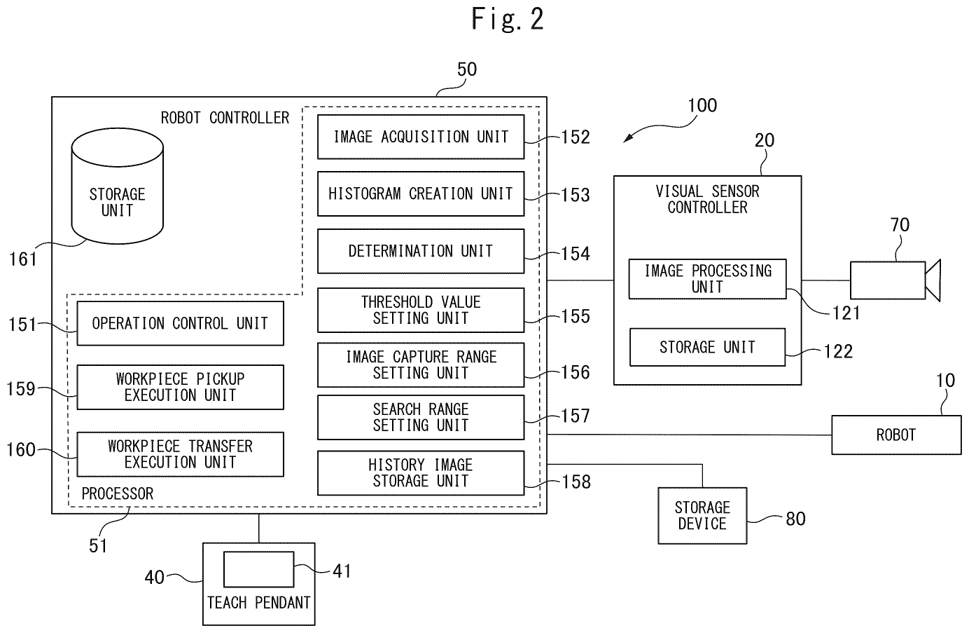

Robot controller 50 controls the operation of robot 10 in accordance with an operation program or a command from teach pendant 40. Robot controller 50 may have a hardware configuration as a common computer including processor 51 (FIG. 2), memories (e.g., a ROM, a RAM, and a nonvolatile memory), a storage, an operation unit, an input-output interface, a network interface, and the like.

Teach pendant 40 is used as an operation terminal for teaching (program creation) of robot 10, and various settings. A teaching device configured with a tablet computer or the like may be used as teach pendant 40. Teach pendant 40 may have a hardware configuration as a common computer including a processor, memories (e.g., a ROM, a RAM, and a nonvolatile memory), a storage, an operation unit, display unit 41 (FIG. 2), an input-output interface, a network interface, and the like. For example, display unit 41 (FIG. 2) includes a liquid crystal display.

Visual sensor controller 20 may have a hardware configuration as a common computer including a processor, memories (e.g., a ROM, a RAM, and a nonvolatile memory), a storage, an operation unit, a display unit, an input-output interface, a network interface, and the like.

FIG. 2 illustrates a functional block diagram of robot controller 50 and visual sensor controller 20. As illustrated in FIG. 2, robot controller 50 includes operation control unit 151, image acquisition unit 152, histogram creation unit 153, determination unit 154, threshold value setting unit 155, image capture range setting unit 156, search range setting unit 157, history image storage unit 158, workpiece pickup execution unit 159, and workpiece transfer execution unit 160. The functional blocks may be provided by execution of software by processor 51 in robot controller 50. Robot controller 50 further includes storage unit 161.

For example, storage unit 161 is a storage configured with a nonvolatile memory, a hard disk device, or the like. A robot program for controlling robot 10, a program (a vision program) for performing image processing such as detection of a workpiece based on an image captured by visual sensor 70, various types of setting information, and the like are stored in storage unit 161.

Operation control unit 151 controls the operation of the robot in accordance with the robot program or a command from teach pendant 40. Robot controller 50 includes a servo control unit (unillustrated) executing servo control on a servomotor on each axis in accordance with a command to the axis generated by operation control unit 151.

Image acquisition unit 152 has a function of acquiring a depth map and a two-dimensional image that are captured by visual sensor 70 from visual sensor controller 20.

Histogram creation unit 153 provides a function of creating a histogram being a frequency distribution related to distance information of each point in an acquired depth map. Histogram creation unit 153 may further have a function of displaying the created histogram on a display screen (e.g., display unit 41 of the teach pendant 40).

Determination unit 154 provides a function of determining whether an object is placed within a range specified by predetermined input information, based on a depth map acquired by image acquisition unit 152. The range specified by the predetermined input information may be a search range searched by determination unit 154 for making a determination or an image capture range of visual sensor 70. As an example, determination unit 154 may be configured to determine whether an object is placed on an inspection target surface within a specified search range, based on a histogram created by histogram creation unit 153.

Threshold value setting unit 155 provides a function for setting a threshold value for distinguishing between distance information of the inspection target surface and distance information of another object on the inspection target surface in a histogram. Threshold value setting unit 155 may have a function of automatically setting the threshold value, based on a depth map captured by visual sensor 70. Threshold value setting unit 155 may be configured to accept setting of the threshold value through a user interface (UI) screen. Alternatively, threshold value setting unit 155 may be configured to accept input of the threshold value from an external device. Threshold value setting unit 155 may set the threshold value in accordance with information related to threshold value setting (e.g., a variable defining the threshold value) described in the robot program (e.g., a workpiece pickup program, a workpiece transfer program, or the vision program).

Image capture range setting unit 156 provides a function for setting an image capture range when the visual sensor 70 captures a depth map. Image capture range setting unit 156 may be configured to accept specification of the image capture range through a UI screen. Image capture range setting unit 156 may be configured to accept input of the image capture range from an external device. Image capture range setting unit 156 may set an image capture range (e.g., a size and a position) in accordance with information being related to specification of the image capture range (e.g., a variable defining the image capture range) and being described in the robot program (e.g., the workpiece pickup program, the workpiece transfer program, or the vision program). Image capture range setting unit 156 transmits a signal instructing visual sensor 70 (visual sensor controller 20) to perform image capture within the set image capture range. When changing the position and posture of robot 10 for movement of the image capture range, image capture range setting unit 156 transmits a command for changing the position and posture of robot 10 to operation control unit 151.

Search range setting unit 157 provides a function of setting a search range searched by determination unit 154 when determination unit 154 determines whether an object is placed in the workspace, based on predetermined input information. For example, the predetermined input information may be information being related to specification of the search range and being described in the robot program (e.g., a variable defining the search range), setting information input through a user interface (UI), information input from an external device, or the like. Details of setting of the search range by search range setting unit 157 will be described later.

History image storage unit 158 provides a function of storing, in, for example, the storage device 80, history information including a history image obtained when workpiece detection processing is executed by visual sensor 70, or the like.

The workpiece pickup program for causing robot 10 to execute pickup work of workpieces loaded in bulk and the workpiece transfer program for causing robot 10 to pick up a workpiece and transfer the workpiece to a separate location are stored in storage unit 161. Workpiece pickup execution unit 159 is a functional block provided by execution of the workpiece pickup program by processor 51. Workpiece pickup execution unit 159 executes the pickup operation of workpieces loaded in bulk in cooperation with operation control unit 151 and visual sensor controller 20. Workpiece transfer execution unit 160 is a functional block provided by execution of the workpiece transfer program by processor 51. Workpiece transfer execution unit 160 executes the transfer operation of a workpiece in cooperation with operation control unit 151 and visual sensor controller 20. Visual sensor controller 20 includes image processing unit 121 and storage unit 122. For example, storage unit 122 is a storage configured with a nonvolatile memory. Storage unit 122 stores various settings used for generation of a depth map, calibration data, and various types of data required for image processing, such as model data of a workpiece. Image processing unit 121 executes various types of image processing such as workpiece detection processing.

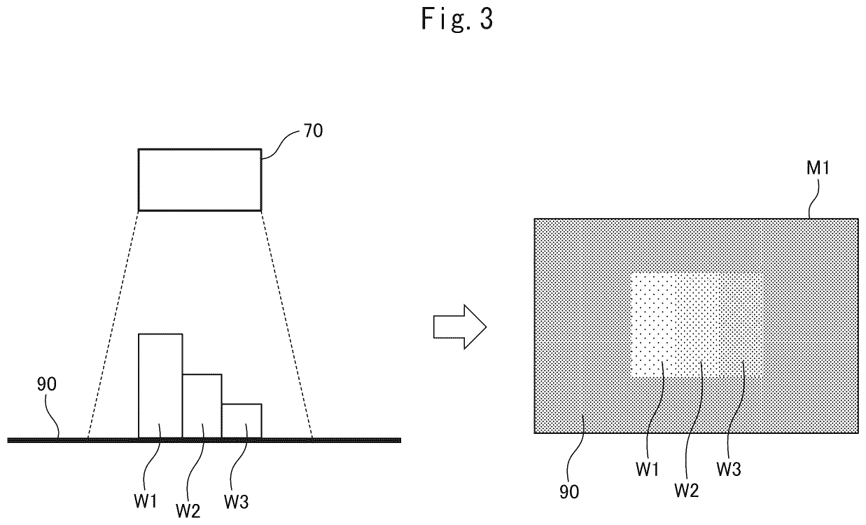

A depth map acquired by the function of visual sensor 70 as a three-dimensional camera will be described with reference to FIG. 3. FIG. 3 illustrates a state of capturing an image of three workpieces W1, W2, and W3 with different heights by visual sensor 70, the workpieces being arranged on floor surface 90, and a captured depth map M1. A depth map is an image in which the brightness varies with the height of an object within an image capture range. In other words, a depth map represents a point cloud in which the brightness of a point varies with the distance from a camera. In the depth map M1, each point is displayed in a color closer to white as the height increases and a color closer to black as the height decreases. Therefore, a part (a point cloud) related to workpiece W1 is displayed in the brightest color, a part (a point cloud) related to workpiece W2 is displayed in a next brightest color, a part (a point cloud) related to workpiece W3 is displayed in a next brightest color, and a part (a point cloud) related to floor surface 90 is displayed in the darkest color in the depth map M1.

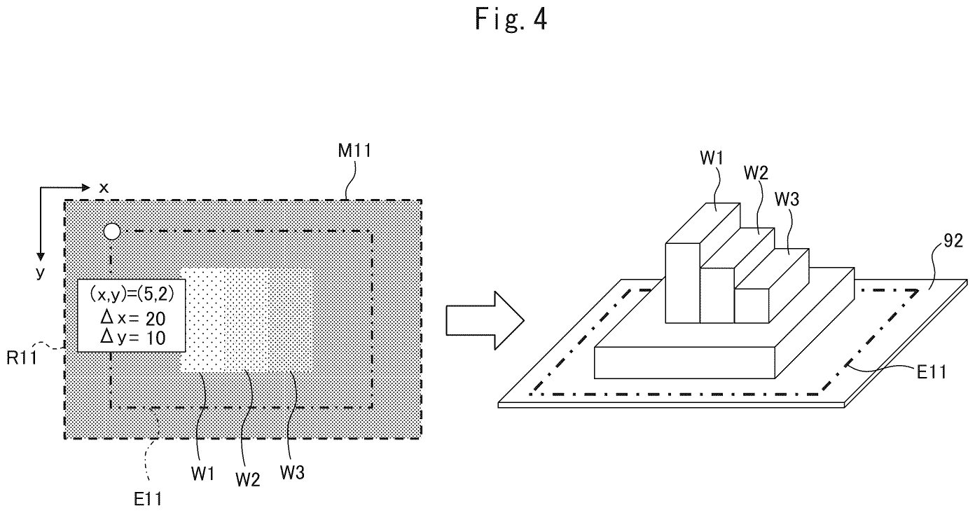

Details of the search range setting function provided by search range setting unit 157 will be described with reference to FIG. 4 to FIG. 7. The search range setting function provided by search range setting unit 157 includes (F1) to (F4) described below.
(F1) A function of setting a search range specified on a captured image as a range defined in a real workspace.
(F2) A function of setting a search range specified on a captured image in association with the image capture range of the visual sensor.
(F3) A function of setting a search range in a real space.
(F4) A function of setting a search range specified in a real space in association with the image capture range of the visual sensor.

In the aforementioned functions (F1) and (F2), search range setting unit 157 accepts input of specifying a search range as a range on an image. As an example, search range setting unit 157 is configured to be able to accept, as a technique of specifying a search range as a range on an image,
(a1) a technique of specifying a search range as numerical value information conforming to coordinates on an image and
(a2) a technique of specifying a search range on a graphical user interface (GUI).

In the aforementioned specification technique (a1), for example, search range setting unit 157 accepts input of specifying a search range E11 as numerical value information conforming to coordinates on depth map M11, as illustrated on the left-hand side of FIG. 4. In the example on the left-hand side of FIG. 4, a coordinate value [(x, y)=(5, 2)] of the upper-left corner and a width (Δx=20, Δy=10) in the x-axis and y-axis directions are specified as the position of the search range E11 in a coordinate system with the upper-left corner of the depth map M11 as the origin. It should be noted that, while an example of defining a search range as a rectangular region and specifying the position and the size of the search range as numerical value information is described, a search range is not limited to a rectangle and may be specified as another shape such as a circle, or a polygon. When a search range is specified as another shape, for example, information specifying a geometric center, an outer diameter, or vertex positions may be used as numerical value information. Search range setting unit 157 may accept such specification of a search range by numerical value information conforming to coordinates on an image as, for example, input from the robot program or may accept a user operation of inputting numerical value information on a UI. It should be noted that such a UI screen may be provided on display unit 41 of the teach pendant 40.

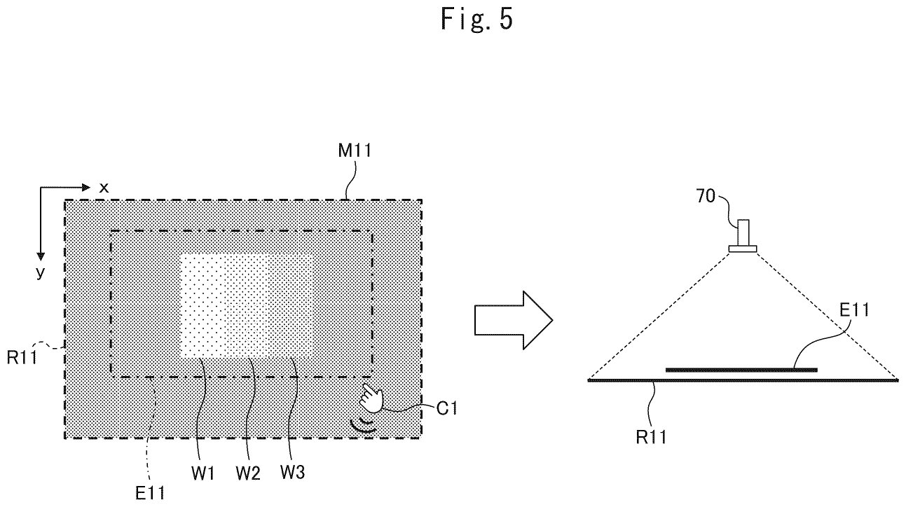

In the aforementioned specification technique (a2), for example, search range setting unit 157 provides a GUI allowing specification of the position and the size of the frame line of a rectangle indicating a search range on the depth map M11, as illustrated in an example on the left-hand side of FIG. 5. For example, such a GUI may be displayed on display unit 41 of the teach pendant 40. An operator can specify the position and the size of a frame indicating search range E11 by moving a cursor C1 by a mouse operation or a touch operation. It should be noted that, while an example of setting a search range as a rectangular region on a GUI is described, a search range may be set as another shape such as a circle or a polygon on the GUI. In the specification method (a2), an operator can specify a search range by an intuitive operation.

Search range setting unit 157 may be configured to accept specification of a search range in the form of simultaneously applying the aforementioned specification techniques (a1) and (a2). In this case, for example, search range setting unit 157 accepts specification by a procedure of setting a search range on the GUI by an operator and then exactly setting the search range by numerical value information.

The aforementioned function (F1) will be described with reference to FIG. 4. As an example, it is assumed that the aforementioned specification technique (a1) is used as the technique for specifying a search range. The depth map M11 illustrated on the left-hand side of FIG. 4 is a depth map of a region on installation surface 92 in the workspace in which workpieces W1 to W3 are arranged (image capture range R11). When the search range E11 is specified on the image by the specification technique (a1), search range setting unit 157 sets the search range E11 specified on the image as a search range defined in the real space (indicated by giving the same sign E11 on the right-hand side of FIG. 4), as illustrated on the right-hand side of FIG. 4. In this case, search range setting unit 157 can make a transformation into the position of the search range in the real space related to the search range on the image by using calibration data and the like.

In this function (F1), search range setting unit 157 defines a search range specified by the specification technique (a1) or (a2) as described above as a range fixed in the real space. Accordingly, even when the position or the posture of visual sensor 70 changes, the search range can remain fixed in the real space.

Based on a depth map, determination unit 154 determines whether an object is placed, with a range corresponding to the search range E11 in the real space as a determination target. Since the search range is set as a range fixed in the real space, even when the position or the posture of visual sensor 70 changes and the image capture range moves, a fixed range in the real space can be set as a determination target. This function (F1) is an effective function when the workplace of the robot is set at a predetermined position.

The aforementioned function (F2) will be described with reference to FIG. 5. As an example, it is assumed that the aforementioned specification technique (a2) is used as the technique for specifying a search range. When the search range E11 is specified on the image, the search range setting unit 157 sets the search range E11 as a range associated with the image capture range R11 of the captured image M11, as illustrated on the right-hand side of FIG. 5. In other words, search range setting unit 157 sets the search range E11 as a range the position of which is fixed relative to the image capture range R11 (see the right-hand side of FIG. 5). Accordingly, when the position or the posture of visual sensor 70 changes and the image capture range R11 moves, the search range E11 follows the movement of the image capture range R11.

In this function, determination unit 154 determines whether an object is placed, with the search range E11 set to the captured depth map M11 as a determination target. Since the search range is set in such a way as to be tied to the image capture range, the range of the determination target on the captured image can be always fixed.

In the aforementioned functions (F3) and (F4), search range setting unit 157 accepts input of specifying a search range as a range in the real workspace. As an example, search range setting unit 157 is configured to be able to accept, as a technique for specifying a search range as a range in the real space,
(b1) a technique of specifying a search range in the real space by operating the robot to perform touch-up and
(b2) a technique of specifying a search range as positional information in the real space from an input source such as the robot program or a user setting.

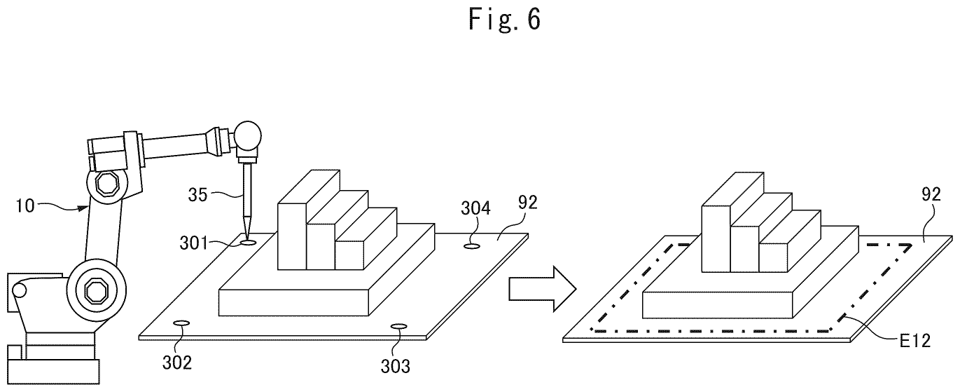

The aforementioned function (F3) will be described with reference to FIG. 6. An example of using the specification technique (b1) will be described. In this function (F3), an operator specifies a search range by performing an operation of touching up a plurality of points in the workspace with touch-up pin 35 attached to the arm tip of robot 10 by operating robot 10, as illustrated on the left-hand side of FIG. 6. In the example illustrated on the left-hand side of FIG. 6, four points 301, 302, 302, and 304 related to the positions of the four corners of a search range are specified on installation surface 92 in the workspace by the touch-up operation. The three-dimensional positions of the points 301 to 304 are acquired by the touch-up operation.

In this case, search range setting unit 157 sets a range of a rectangle having the four points 301 to 304 as four corners as a search range E12 in the real space, as illustrated on the right-hand side of FIG. 6. In this function (F3), the search range E12 is set as a range fixed in the real space. The operator can set a search range at a desired position in the workspace.

Determination unit 154 determines whether an object is placed, using a range, in the depth map, corresponding to the search range E12 in the real space as a determination target. It should be noted that, when performing image processing such as determination on an image, determination unit 154 acquires a search range on the image related to the search range E12 specified as a position in the real space, based on the calibration data or the like. In this example, the search range is determined in the real space, and therefore, even when the position or the posture of visual sensor 70 changes and the image capture range moves, a fixed range in the real space can be set as a determination target. This function (F3) is an effective function when the workplace of the robot is set at a predetermined position.

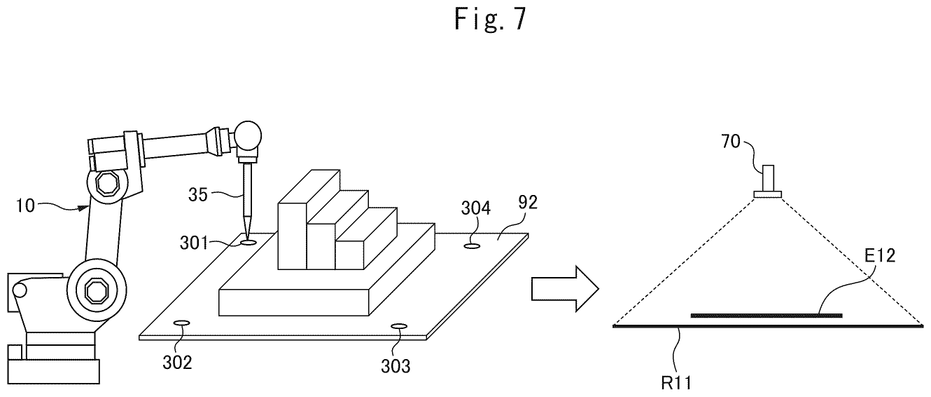

The aforementioned function (F4) will be described with reference to FIG. 7. An example of using the aforementioned specification technique (b1) will be described. An operator specifies a plurality of points in the real space by operating the robot to perform touch-up, similarly to the aforementioned function (F3) (see the left-hand side of FIG. 7). Thus, three-dimensional coordinate values representing the positions of the four corners of a search range are acquired.

Search range setting unit 157 sets a search range E12 in the real space specified by the touch-up operation as a search range associated with the image capture range R11 of the visual sensor 70 (indicated by giving the same sign E12 on the right-hand side of FIG. 7). Accordingly, in this function, the search range E12 is set as a position based on the image capture range R11, and even when the position or the posture of the visual sensor changes and the image capture range R11 moves, the search range follows the movement. In other words, the position of the search range in the captured image can be always fixed.

In this function, determination unit 154 determines whether an object is placed, with the search range E12 set to the depth map of the image capture range R11 as a determination target. Since the search range is set in such a way as to be tied to the image capture range, the range of the determination target on a captured image can be always fixed.

As described above, according to the present embodiment, a search range may be specified as a range on an image or may be specified as a range in the real space. Accordingly, an operator can specify a suitable search range according to various conditions including the content of the work, an environmental condition of the workspace, and the like. As described above, a specification technique based on the robot program, a specification technique based on a user input through a UI, a specification technique based on operation of the robot to perform touch-up, and the like may be employed as the input technique for specifying a search range. Thus, the present embodiment can provide a high degree of freedom related to the specification technique of a search range.

Determination unit 154 determines whether an object is placed, based on a depth map, with a search range set as described above as a determination target. As a specific example of processing of determining, by determination unit 154, whether an object is placed within a search range, a case of performing an operation of determining whether an object is placed on the inspection target surface, based on a frequency distribution (histogram) created from the depth map by histogram creation unit 153 will be described below. A technique other than the technique using a frequency distribution (histogram) illustrated herein may be used as the technique for determining whether an object is placed.

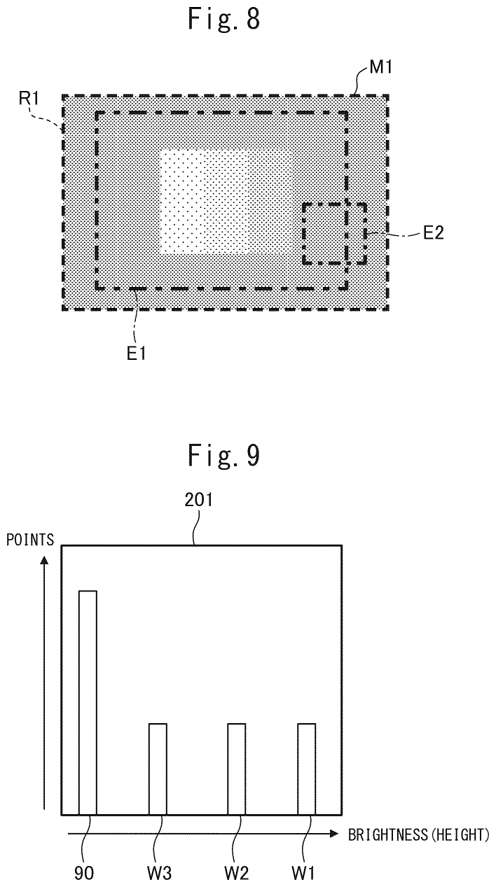

Histogram creation unit 153 creates a histogram with distance (brightness) as a variable for an image in which the brightness varies with distance, such as the depth map M1. In creation of a histogram, histogram creation unit 153 may be configured to create a histogram by searching a point cloud within a search range set on a depth map by the function of search range setting unit 157. The depth map M1 acquired as illustrated in FIG. 3 will be described as an example. It is assumed that a search range E1 is specified on the depth map M1 as illustrated in FIG. 8. FIG. 9 illustrates a histogram 201 created by histogram creation unit 153 in this case. In the histogram 201 in FIG. 9, the horizontal axis (a variable) represents the brightness of a point, and the vertical axis represents the sum of the number of points (a frequency). In the search range E1, the ratio of floor surface 90 is highest, and therefore, the frequency of floor surface 90 represented by the darkest point cloud is indicated highest. The top surfaces of workpieces W1, W2, and W3 with heights different from each other have the same area. Therefore, the respective frequencies of the point clouds of the brightness representing workpieces W1, W2, and W3 are the same.

Referring to FIG. 9, it can be understood that specification of the brightness of floor surface 90 as an inspection target surface allows determination of whether an object with a height different from that of floor surface 90 is placed on floor surface 90. In the example in FIG. 9, since point clouds with brightness different from that of floor surface 90 are distributed at three locations, three workpieces W1, W2, and W3 with different heights can be determined to be placed on floor surface 90. As for specification of the brightness of the inspection target surface (floor surface 90), the brightness of the inspection target surface (a threshold value for determining whether given brightness is the brightness of the inspection target surface) may be set by a user input. The brightness of the inspection target surface (the threshold value for determining whether given brightness is the brightness of the inspection target surface) may be automatically set by determination unit 154. Details of the method for setting the brightness of the inspection target surface (the threshold value for determining whether given brightness is the brightness of the inspection target surface) will be described later.

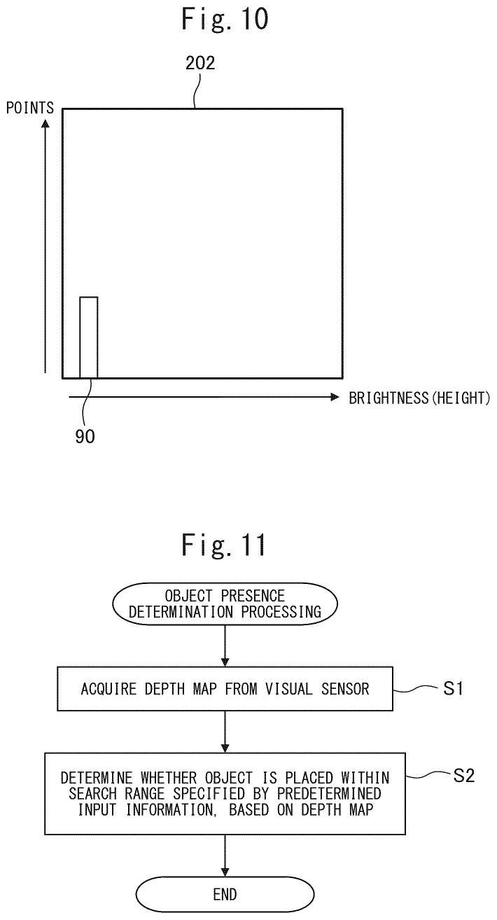

A case of a search range E2 being specified on the depth map M1 as illustrated in FIG. 8 will be considered. FIG. 10 illustrates a histogram 202 created by histogram creation unit 153 in this case. Since the search range E2 is a region including only floor surface 90, there is only one type of brightness having a frequency in the histogram 202, and the frequency is lower compared with the case of the search range E1.

By specifying a wide search range, such as the search range E1, within an image capture range R1, a histogram can be acquired for a wide range and the presence of an object within the wide range can be confirmed. On the other hand, specifying a relatively narrow search range, such as the search range E2, is useful when high-speed determination of the presence of an object for a limited region is desired. Further, limiting a search range to a relatively narrow range can reduce the possibility of inclusion of an outlier in a histogram.

FIG. 8 also illustrates the image capture range R1 of visual sensor 70. Image capture range setting unit 156 accepts specification of the size and the position of an image capture range within an allowable image capture range of visual sensor 70. Image capture range setting unit 156 may be configured to provide a graphical user interface for setting at least one of the size and the position of a rectangular image representing an image capture range on a screen as illustrated in FIG. 8. Such a user interface may be provided on display unit 41 of the teach pendant 40.

Histogram creation unit 153 may have a function of displaying a histogram (e.g., the histogram 201 or 202) created for a range (an image capture range or a search range) specified as described above on, for example, display unit 41 of the teach pendant 40 in response to a predetermined operation on the operation unit of the teach pendant 40. It should be noted that histogram creation unit 153 may have a function of storing distance information within a specified range (an image capture range or a search range) into, for example, storage unit 161 as numerical value information (a numerical value table representing a histogram) and displaying the distance information on, for example, display unit 41 of the teach pendant 40 in response to a predetermined operation on the operation unit of the teach pendant 40.

As described above, robot controller 50 has a function of determining whether an object is placed within a search range specified by predetermined input information. FIG. 11 is a flowchart generally describing such a function (object presence determination processing) provided by determination unit 154. This processing is executed under the control of processor 51. As illustrated in FIG. 11, image acquisition unit 152 acquires a depth map captured by visual sensor 70 (step S1). Next, determination unit 154 determines whether an object is placed within the search range specified by the predetermined input information, based on the depth map (step S2).

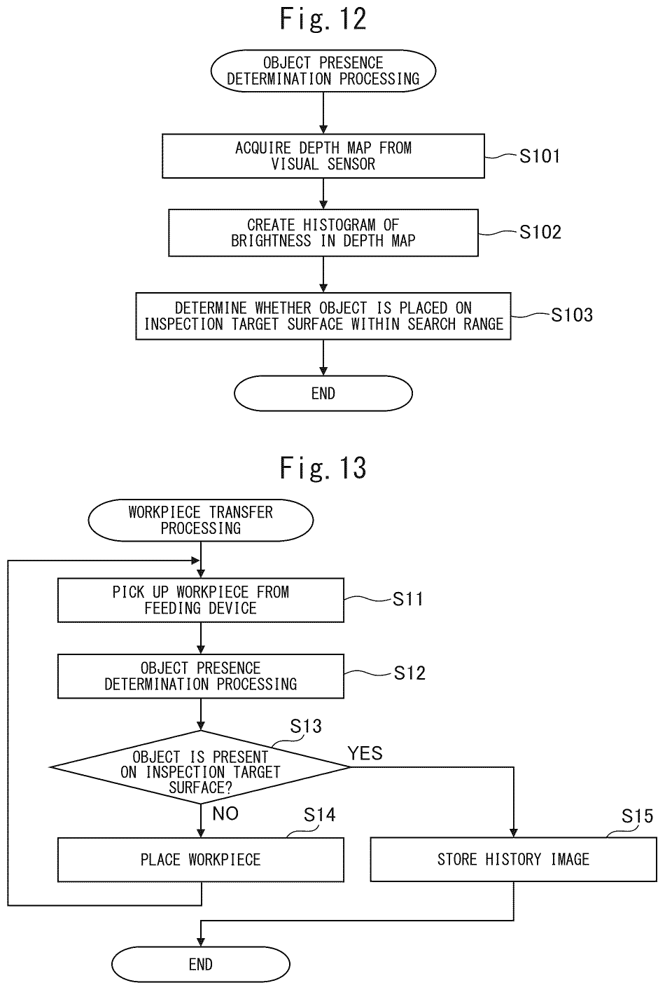

According to the present embodiment, robot controller 50 is configured to be able to determine whether an object is placed on an inspection target surface (floor surface 90 in the case of the histogram 201), based on the aforementioned histogram. FIG. 12 is a flowchart illustrating a specific operation example of the object presence determination processing executed by robot controller 50 (processor 51). First, image acquisition unit 152 acquires, from visual sensor 70, a depth map in which an image capture range including an inspection target surface is captured (step S101). Next, histogram creation unit 153 creates a histogram of brightness in the depth map (step S102). The histogram may be created for the inside of a search range set as described above. Then, determination unit 154 determines whether an object is placed on the inspection target surface within the search range, based on the histogram related to brightness in the depth map (step S103).

The details about the object presence determination processing will be described below by citing two examples of applying the object presence determination processing in FIG. 12 to handling work on a workpiece by robot 10.

A first example is an operation example of applying the object presence determination processing to transfer work of a workpiece by workpiece transfer execution unit 160. FIG. 13 is a flowchart in a case of applying the object presence determination processing to workpiece transfer processing. This processing is executed under the control of processor 51 in robot controller 50.

Workpiece transfer execution unit 160 picks up a workpiece from a feeding device such as a belt conveyor by robot 10 (step S11). In placement of the workpiece on the destination of the workpiece (e.g., a conveying device or a worktable), workpiece transfer execution unit 160 executes the object presence determination processing in order to confirm that no object is placed on the destination (step S12). It is assumed in this example that the operation of placing the workpiece on the destination is taught to robot 10 on the assumption that no object (obstacle) is present on the destination.

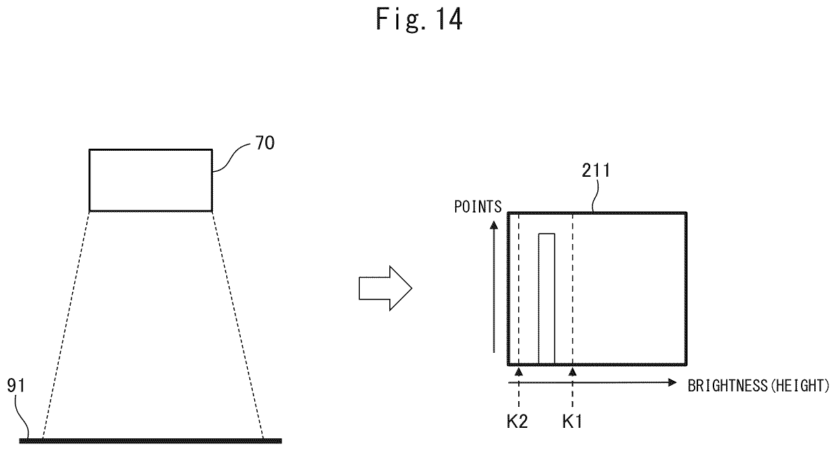

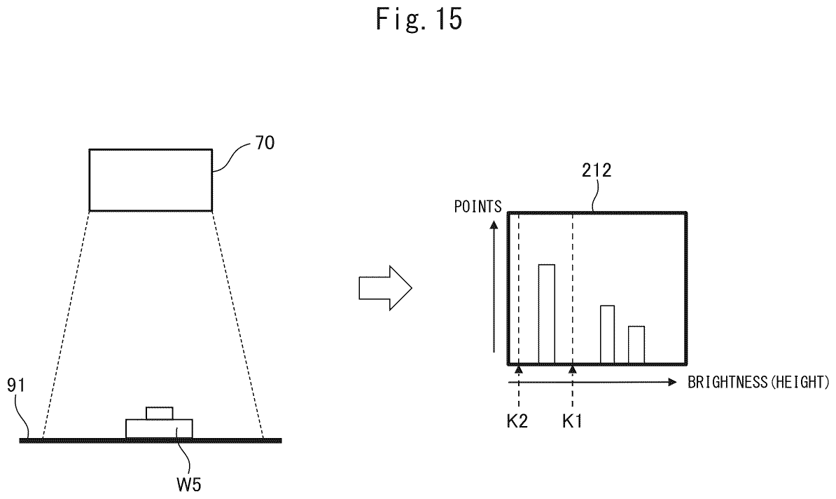

A specific example of the object presence determination processing executed in step S12 will be described with reference to FIG. 14 and FIG. 15. FIG. 14 illustrates a state in which visual sensor 70 captures a depth map in a situation in which nothing is placed on placement surface 91 being the destination and illustrates a histogram 211 of the depth map acquired at that time. FIG. 15 illustrates a state in which visual sensor 70 captures a depth map in a situation in which workpiece W5 is placed on placement surface 91 and illustrates a histogram 212 acquired at that time.

Robot controller 50 may acquire, in advance, the histogram 211 acquired in the state in which nothing is placed on placement surface 91 and store the histogram in storage unit 161. Determination unit 154 can determine whether an object is placed on placement surface 91 by comparison between the prestored histogram 211 and the histogram 212 of the depth map acquired in step S12 at execution of the workpiece transfer processing.

As illustrated in the histogram 211 in FIG. 14, threshold value setting unit 155 provides a function of setting threshold values for determining whether a frequency of a height (brightness) other than the height (brightness) of placement surface 91 is present in the depth map. For example, the threshold values may be set as an upper limit K1 and a lower limit K2 for determining, with reference to the height (brightness) of placement surface 91, a range including the reference height (brightness), as illustrated in FIG. 14. Determination unit 154 can determine that an object is placed on placement surface 91 when the presence of a point cloud with brightness outside the range determined by the upper limit K1 and the lower limit K2 is perceived.

The threshold values (the upper limit K1 and the lower limit K2) may be set by a user or may be automatically set by threshold value setting unit 155. Threshold value setting unit 155 may perform automatic setting of the threshold values (the upper limit K1 and the lower limit K2) by the following procedure:
r1) specify brightness having a frequency in the prestored histogram 211 as the brightness of placement surface 91, and
r2) set, as the upper limit K1, brightness acquired by adding a predetermined margin to the brightness of placement surface 91, and set, the lower limit K2, brightness acquired by subtracting a predetermined margin from the brightness of placement surface 91.

A technique of automatically setting the threshold values by threshold value setting unit 155, based on a depth map previously acquired in a state in which nothing is present on the inspection target surface has been described. As another technique, for example, an algorithm determining a point cloud satisfying a condition being:
(d1) having the highest frequency in the depth map at inspection or
(d2) having the highest frequency and the darkest color in the depth map at inspection to be the inspection target surface may be employed depending on the situation of the inspection target surface. The algorithm (d1) is effective in a situation in which basically not so many objects are assumed to be placed on the inspection target surface in many cases. The algorithm (d2) is effective when basically not so many objects are placed on the inspection target surface in many cases and the inspection target surface is at the lowest position within an image capture range (or within a search range), such as a floor surface.

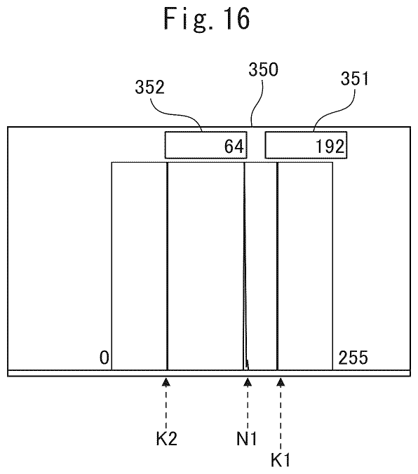

When threshold value setting unit 155 accepts user setting of the threshold values (the upper limit K1 and the lower limit K2), a graphical user interface screen (GUI screen 350) as illustrated in FIG. 16 may be provided to display unit 41 of the teach pendant 40. GUI screen 350 illustrated in FIG. 16 is configured to display a histogram created by histogram creation unit 153, based on a depth map captured in a state in which no object is present on the inspection target surface, and accept setting of the threshold values on the screen. GUI screen 350 illustrated in FIG. 16 is configured to allow entry of the upper limit K1 and the lower limit K2 being the threshold values into numerical value entry fields 351 and 352 with the brightness N1 of the inspection target surface being sandwiched between the threshold values. A user can set a desired upper limit K1 and a desired lower limit K2 being the threshold values to the numerical value entry fields 351 and 352. Thus, by allowing setting of the threshold values on a screen displaying a histogram of the inspection target surface, the user can intuitively perform setting of the threshold values with reference to the histogram.

A situation in which workpiece W5 remains on placement surface 91 at inspection (i.e., in the object presence determination processing in step S12) as illustrated in FIG. 15 is assumed. In this case, the histogram 212 as illustrated on the right-hand side of FIG. 15 is generated. Then, determination unit 154 specifies the presence of a point cloud with brightness exceeding the upper limit K1 being the threshold value (i.e., the presence of workpiece W5). In this case, an object is determined to be placed on the inspection target surface in step S13 (S13: YES), the work of placing a workpiece is interrupted, and the processing advances to step S15.

On the other hand, when an object is determined not to be placed on the inspection target surface in step S13 (S13: NO), workpiece transfer execution unit 160 executes the work of placing a workpiece on placement surface 91 (step S14). Then, workpiece transfer execution unit 160 may continue the work of picking-up and transferring a next workpiece.

In step S15, history image storage unit 158 stores, as a history image, a two-dimensional image in which the state in which workpiece W5 remains on placement surface 91 is captured by the two-dimensional camera function of visual sensor 70 into storage device 80 together with other history information. Then, workpiece transfer execution unit 160 ends this processing.

Thus, according to the workpiece transfer processing according to the present embodiment, the absence of an object at a location where a workpiece is to be placed can be reliably detected, and therefore, safety in the operation of placing a workpiece can be improved. In case some object (obstacle) is present at a location where a workpiece is to be placed, the work of placing the workpiece by the robot can be interrupted. Therefore, the occurrence of a malfunction (e.g. suspension of a production cycle) due to the robot performing the operation of placing a workpiece at a location where another workpiece is placed and causing interference between the workpieces can be prevented. Accordingly, the present embodiment enables safer and smoother workpiece transfer processing.

The history image stored in step S15 can be utilized in recognition of the situation in which workpiece W5 remains on placement surface 91, analysis of the cause, and the like. Further, necessary measures can be taken by utilization of the history image.

Histogram creation unit 153 may be configured to display a histogram based on a depth map acquired by visual sensor 70 on a display screen (display unit 41) in response to a predetermined user operation while the workpiece transfer processing is performed. In the workpiece transfer processing, determination unit 154 may determine whether an object is placed on the inspection target surface in a set range (an image capture range or a search range).

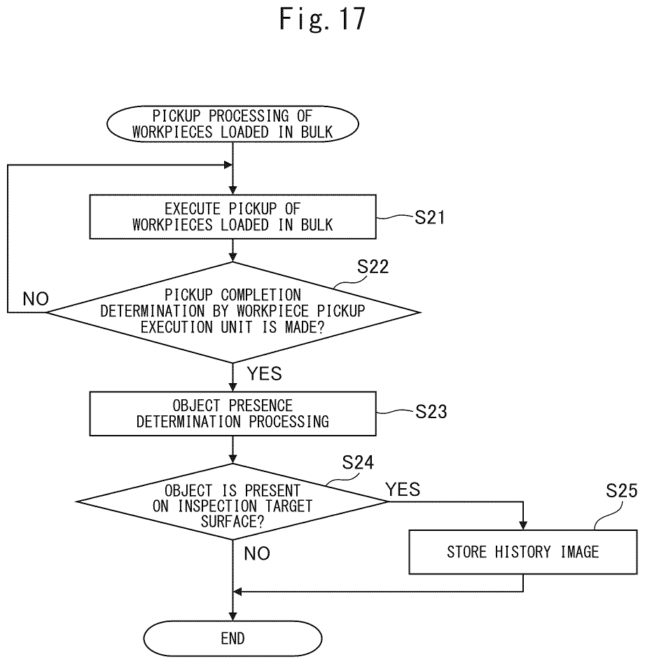

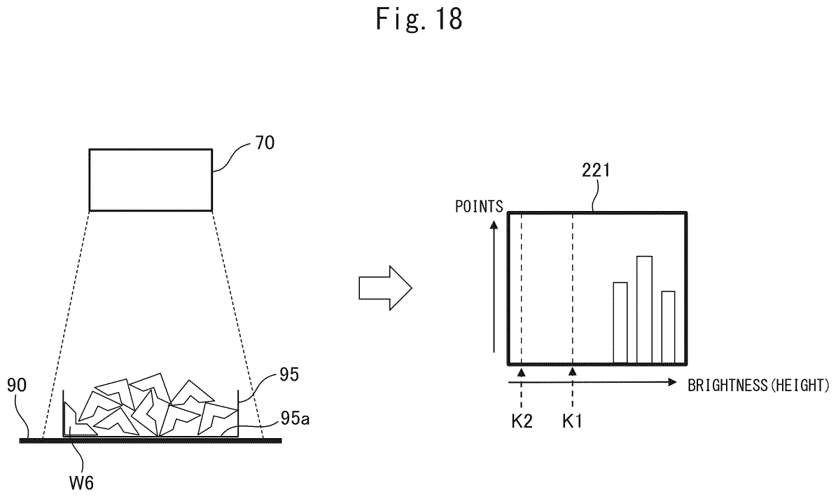

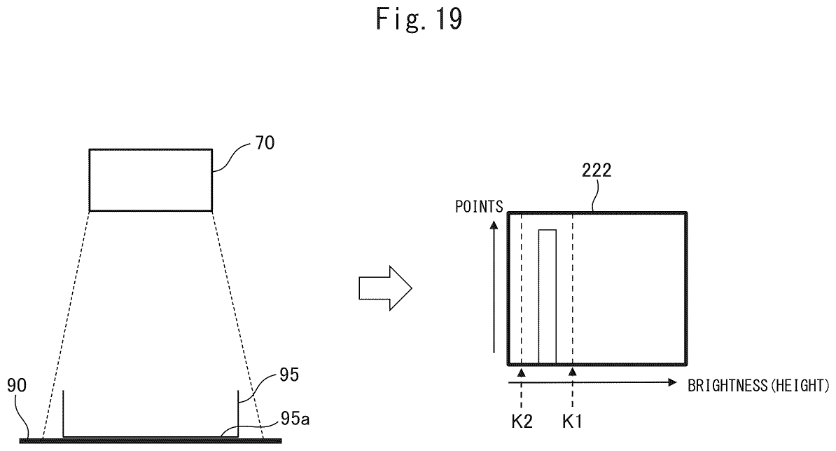

A second example of applying the object presence determination processing to handling work of a workpiece by robot 10 will be described. The second example is an operation example of applying the object presence determination processing to pickup processing of workpieces loaded in bulk performed by workpiece pickup execution unit 159. FIG. 17 is a flowchart in a case of applying the object presence determination processing to the pickup processing of workpieces loaded in bulk. This processing is executed under the control of processor 51 of the robot controller 50. It is assumed that work of picking-up workpieces W6 loaded in bulk (only part of the workpieces is given a sign) in container 95 on floor surface 90 is executed as illustrated in FIG. 18 and FIG. 19.

Workpiece pickup execution unit 159 executes the pickup processing of workpieces loaded in bulk in accordance with the workpiece pickup program stored in storage unit 161 (step S21). Then, workpiece pickup execution unit 159 determines whether the pickup of the workpieces loaded in bulk is completed by a predetermined completion determination condition (step S22). For example, the predetermined completion determination condition is non-detection of workpiece W6 as a detection result of executing detection processing of workpiece W6, based on a two-dimensional image in which the inside of container 95 is captured by visual sensor 70. When pickup of the workpiece is determined not to be completed (S22: NO), the pickup processing of workpieces is continued.

When workpiece pickup execution unit 159 determines that the pickup processing of the workpiece is completed (S22: YES), the object presence determination processing is executed (step S23). In this object presence determination processing, whether workpiece W6 remains in container 95 is determined.

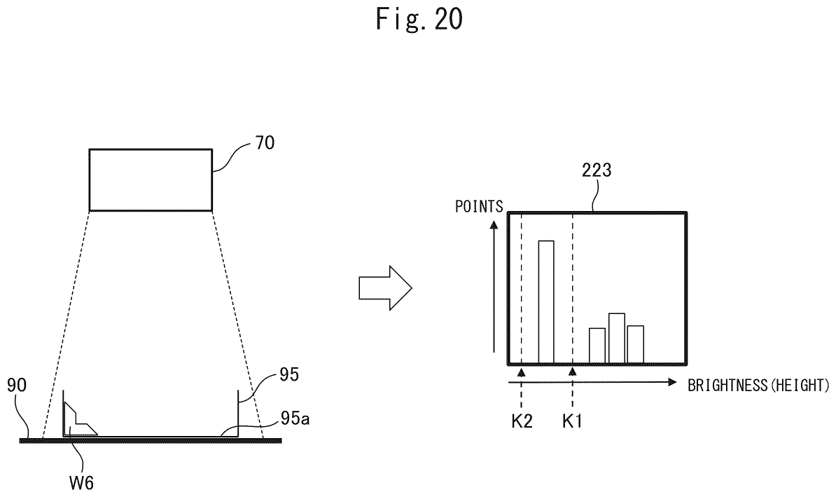

The object presence determination processing executed in step S23 will be described with reference to FIG. 18 to FIG. 20. FIG. 18 illustrates a situation in which visual sensor 70 captures a depth map in a state in which many workpieces W6 are present in container 95, and a histogram 221 of the depth map acquired at that time. FIG. 19 illustrates a situation in which visual sensor 70 captures a depth map in a situation in which no object is present in container 95, and a histogram 222 of the depth map acquired at that time. FIG. 20 illustrates a situation in which visual sensor 70 captures a depth map in a situation in which one workpiece W6 remains in container 95, and a histogram 223 of the depth map acquired at that time.

It should be noted that it is assumed in this example that the histogram 222 acquired in the situation in which no object is present in container 95 as illustrated in FIG. 19 is prestored in storage unit 161. It is assumed that threshold value setting unit 155 specifies the height (brightness) of bottom surface 95a of container 95, based on the histogram 222, and determines the upper limit K1 and the lower limit K2 being the threshold values based on the brightness. Specification of the brightness of bottom surface 95a and setting of the threshold values (the upper limit K1 and the lower limit K2) can be performed by the aforementioned procedures (r1) and (r2). It should be noted that, in the situation in which many workpieces W6 are present in container 95 as illustrated in FIG. 18, many point clouds are distributed in a brightness range beyond the range determined by the upper limit K1 and the lower limit K2 being the threshold values based on bottom surface 95a in the histogram 221. On the other hand, in the situation in which no workpiece W6 remains in the container as illustrated in FIG. 19, no point cloud having a frequency in the brightness range beyond the range determined by the upper limit K1 and the lower limit K2 being the threshold values based on bottom surface 95a is present.

When no point cloud having brightness beyond the range determined by the upper limit K1 and the lower limit K2 being the threshold values is present as a result of the object presence determination processing, it is determined that no object is present on bottom surface 95a as the inspection target surface (S24: NO). In this case, pickup of the workpieces loaded in bulk is suitably ended, and this processing is ended.

It is assumed that workpiece W6 remains in container 95 as illustrated in FIG. 20 when the object presence determination processing is executed. In this case, determination unit 154 determines the presence of an object on the inspection target surface, based on the histogram 223 illustrated in FIG. 20. In the histogram 223, distribution of a point cloud is perceived in a brightness range beyond the range determined by the upper limit K1 and the lower limit K2 being the threshold values. Accordingly, in this case, determination unit 154 determines that an object is present on bottom surface 95a being the inspection target surface (S24: YES).

In this case (S24: YES), history image storage unit 158 stores, as a history image, a two-dimensional image in which the state in which workpiece W6 remains on bottom surface 95a is captured by the two-dimensional camera function of visual sensor 70, in storage device 80 together with other history information (step S25). Then, workpiece pickup execution unit 159 ends this processing.

As described above, the workpiece pickup processing according to the present embodiment enables reliable detection of a malfunction that the robot controller makes a workpiece pickup completion determination in a state in which a workpiece remains in the container.

The history image stored in step S25 can be utilized for analyzing the cause of workpiece pickup execution unit 159 making the pickup completion determination in the state in which workpiece W6 remains. For example, in a situation in which one side of workpiece W6 remains in close contact with the inner surface of container 95 as illustrated in FIG. 20, it may be assumed that detection processing of applying pattern matching to a two-dimensional image cannot satisfactorily detect workpiece W6. On the other hand, as described above, determination by the object presence determination processing can suitably determine the presence of workpiece W6. Accordingly, by storing the situation in which workpiece W6 remains as illustrated in FIG. 20 as a history image, the aforementioned cause can be analyzed, and necessary measures can be taken.

It should be noted that, in the aforementioned second example, the image capture range or the search range may be previously adjusted in such a way that the side of container 95 is not measured. By thus setting the image capture range or the search range, frequencies of only the heights of bottom surface 95a of container 95 and workpiece W6 (when workpiece W6 is present) appear in the histogram, which enables more satisfactory object presence determination.

As described above, according to the present embodiment, whether an object is placed at an inspection target location can be reliably determined, and prevention of the occurrence of a malfunction in handling work of a workpiece by the robot and detection of the occurrence of a malfunction can be reliably performed.

In the aforementioned embodiment, the placement of functions in the functional block diagram illustrated in FIG. 2 is an example, and various modified examples may be configured for the placement of functions. For example, a configuration of placing part of the functional blocks placed in robot controller 50 (e.g., threshold value setting unit 155, image capture range setting unit 156, and search range setting unit 157) on teach pendant 40 side is a possible example.

The functions as teach pendant 40 (e.g., the functions of the display unit and the operation unit as user interfaces) may be included in the functions of robot controller 50 and the functions of the robot controller may be defined as such.

While an operation example of determining whether an object is placed within a search range by using a histogram of a depth map by determination unit 154 has been described in the aforementioned embodiment, the operation example of determining whether an object is placed within a search range by the determination unit is not limited to the above. For example, determination unit 154 may determine whether an object is placed within a specified search range by using distance data of each point in a depth map. In this case, for example, when the presence of an object with a specific height based on the height of a reference plane in a search range is perceived, the object may be determined to be placed within the search range (on the reference plane). It should be noted that when the determination unit is configured as described above, the functions related to determination based on a histogram (histogram creation unit 153 and threshold value setting unit 155) may be omitted.

The functional blocks in the robot controller and the visual sensor controller that are illustrated in FIG. 2 may be provided by executing various types of software stored in the storage by the processors of the controllers or may be provided by a configuration mainly based on hardware such as an application specific integrated circuit (ASIC).

The aforementioned object presence determination processing (FIG. 11 and FIG. 12) can be executed on various information processing devices.

Programs executing various types of processing such as the object presence determination processing (FIG. 11 and FIG. 12), the workpiece transfer processing (FIG. 13), and the workpiece pickup processing (FIG. 17) in the aforementioned embodiment can be recorded on various computer-readable recording media (e.g., semiconductor memories such as a ROM, an EEPROM, and a flash memory; a magnetic recording medium; and optical disks such as a CD-ROM and a DVD-ROM).

While the present disclosure has been described in detail, the present disclosure is not limited to each of the aforementioned embodiments. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto. Further, the above also holds when a numerical value or a mathematical expression is used in the description of the aforementioned embodiments.

The following Supplementary Notes are further disclosed with regard to the aforementioned embodiments and the modified examples thereof.

### Supplementary Note 1

A controller (50) including an image acquisition unit (152) configured to acquire a depth map captured by a visual sensor (70) and a determination unit (154) configured to determine whether an object is placed within a range specified by predetermined input information, based on the depth map.

### Supplementary Note 2

The controller (50) according to Supplementary Note 1, further including a search range setting unit (157) configured to set the range specified by the predetermined input information as a search range.

### Supplementary Note 3

The controller (50) according to Supplementary Note 2, wherein the predetermined input information is information specifying the search range as a range on an image.

### Supplementary Note 4

The controller (50) according to Supplementary Note 2, wherein the predetermined input information is information specifying the search range as a range in a real space.

### Supplementary Note 5

The controller (50) according to any one of Supplementary Notes 1 to 4, wherein the predetermined input information is described in a robot program.

### Supplementary Note 6

The controller (50) according to any one of Supplementary Notes 1 to 4, wherein the predetermined input information is information input through a user interface.

### Supplementary Note 7

The controller (50) according to any one of Supplementary Notes 2 to 4, wherein the search range setting unit (157) sets the search range as a range defined in a real space.

### Supplementary Note 8

The controller (50) according to any one of Supplementary Notes 2 to 4, wherein the search range setting unit (157) sets the search range as a range associated with an image capture range of the visual sensor (70).

### Supplementary Note 9

The controller (50) according to Supplementary Note 3, wherein the range on the image is represented as numerical value information based on a coordinate on the image.

### Supplementary Note 10

The controller (50) according to Supplementary Note 3, wherein the search range setting unit (157) provides a graphical user interface for specifying the range on the image by a graphical operation.

### Supplementary Note 11

The controller (50) according to Supplementary Note 4, wherein the search range setting unit (157) acquires, as the information specifying the search range as a range in a real space, three-dimensional coordinates of a plurality of points in a real space acquired by causing a robot (10) to execute an operation of touching up the plurality of points.

### Supplementary Note 12

The controller (50) according to Supplementary Note 1, further including an image capture range setting unit (156) configured to set the range specified by the predetermined input information as the image capture range within which the visual sensor (70) captures an image, wherein the image capture range setting unit (156) transmits, to the visual sensor (70), a signal instructing the visual sensor to perform image capture in the set image capture range.

### Supplementary Note 13

The controller (50) according to any one of Supplementary Notes 1 to 12, wherein the determination unit (154) determines whether an object is placed on an inspection target surface within the specified range.

### Supplementary Note 14

The controller (50) according to Supplementary Note 13, wherein the determination unit (154) determines whether an object is placed on the inspection target surface, based on a frequency distribution related to distance information of each point in the acquired depth map.

### Supplementary Note 15

The controller (50) according to Supplementary Note 14, further including a threshold value setting unit (155) configured to set a threshold value for distinguishing between distance information of the inspection target surface in the frequency distribution and distance information of another object on the inspection target surface, wherein the determination unit (154) determines whether an object is placed on the inspection target surface by using the threshold value.

### Supplementary Note 16

The controller (50) according to Supplementary Note 15, wherein the threshold value setting unit (155) sets the threshold value, based on a frequency distribution related to distance information of each point in a depth map acquired in a situation in which no object is placed on the inspection target surface.

### Supplementary Note 17

The controller (50) according to Supplementary Note 15, wherein the threshold value setting unit (155) is configured to provide a user interface accepting setting of the threshold value by a user operation.

### Supplementary Note 18

The controller (50) according to Supplementary Note 17, wherein the user interface is configured as a graphical user interface including an image representing a frequency distribution of the depth map.

### Supplementary Note 19

The controller (50) according to Supplementary Note 15, wherein the threshold value setting unit (155) sets the threshold value in accordance with threshold value information described in a robot program.

### Supplementary Note 20

The controller (50) according to any one of Supplementary Notes 14 to 19, further including a histogram creation unit (153) configured to generate an image representing the frequency distribution, based on distance information of each point in the acquired depth map, and display the image on a display screen.

### Supplementary Note 21

The controller (50) according to Supplementary Note 20, wherein the histogram creation unit (153) is configured to generate an image representing the frequency distribution in a specified range in the depth map.

### Supplementary Note 22

The controller (50) according to any one of Supplementary Notes 14 to 21, further including a workpiece transfer execution unit (160) configured to execute workpiece transfer work of picking up a workpiece from a feeding device and placing the workpiece on a predetermined placement surface by a robot (10), wherein the determination unit (154) determines whether an object is present on the placement surface, based on a depth map in which the placement surface is captured before the workpiece transfer execution unit (160) places the workpiece on the placement surface.

### Supplementary Note 23

The controller (50) according to any one of Supplementary Notes 14 to 21, further including a workpiece pickup execution unit (159) configured to execute pickup work of a robot (10) picking up one or more workpieces loaded in bulk in a container, wherein, when the workpiece pickup execution unit (159) makes a completion determination on pickup of one or more workpieces, based on a predetermined completion determination condition, the determination unit (154) determines whether an object is present on a bottom surface of the container, based on a depth map in which a bottom surface of the container is captured.

### Supplementary Note 24

The controller (50) according to Supplementary Note 22 or 23, further including a history image storage unit (158) configured to store a history image when an object is determined to be present by the determination unit (154).

### Supplementary Note 25

The controller according to any one of Supplementary Notes 14 to 24, wherein the depth map is an image representing the distance information of each point by brightness, and the frequency distribution represents a distribution of brightness of each point in the depth map.

### Supplementary Note 26

A robot system (100) including a robot (10), a visual sensor (70), and the controller (50) according to any one of Supplementary Notes 1 to 25, wherein the controller (50) controls the robot (10).

### Supplementary Note 27

An object presence determination method executed on an information processing device, the method including:
acquiring a depth map captured by a visual sensor (70); and
determining whether an object is placed within a range specified by predetermined input information, based on the depth map.

### Supplementary Note 28

A program for causing a processor in a computer to execute:
a step of acquiring a depth map captured by a visual sensor (70); and
a step of determining whether an object is placed within a range specified by redetermined input information, based on the depth map.

### REFERENCE SIGNS LIST

10 Robot
20 Visual sensor controller
33 Hand
40 Teach pendant
50 Robot controller
51 Processor
70 Visual sensor
80 Storage device
90 Floor surface
91 Placement surface
95 Container
95a Bottom surface
100 Robot system
121 Image processing unit
122 Storage unit
151 Operation control unit
152 Image acquisition unit
153 Histogram creation unit
154 Determination unit
155 Threshold value setting unit
156 Image capture range setting unit
157 Search range setting unit
158 History image storage unit
159 Workpiece pickup execution unit
160 Workpiece transfer execution unit
161 Storage unit
350 GUI screen

What is claimed is:

1. A controller comprising:
an image acquisition unit configured to acquire a depth map captured by a visual sensor; and
a determination unit configured to determine whether an object is placed within a range specified by predetermined input information, based on the depth map.

2. The controller according to claim 1, further comprising a search range setting unit configured to set the range specified by the predetermined input information as a search range.

3. The controller according to claim 2, wherein the predetermined input information is information specifying the search range as a range on an image.

4. The controller according to claim 2, wherein the predetermined input information is information specifying the search range as a range in a real space.

5. The controller according to claim 1, wherein the predetermined input information is described in a robot program.

6. The controller according to claim 1, wherein the predetermined input information is information input through a user interface.

7. The controller according to claim 2, wherein the search range setting unit sets the search range as a range defined in a real space.

8. The controller according to claim 2, wherein the search range setting unit sets the search range as a range associated with an image capture range of the visual sensor.

9. The controller according to claim 3, wherein the range on the image is represented as numerical value information based on a coordinate on the image.

10. The controller according to claim 3, wherein the search range setting unit provides a graphical user interface for specifying the range on the image by a graphical operation.

11. The controller according to claim 4, wherein the search range setting unit acquires, as the information specifying the search range as a range in a real space, three-dimensional coordinates of a plurality of points in a real space acquired by causing a robot to execute an operation of touching up the plurality of points.

12. The controller according to claim 1, further comprising an image capture range setting unit configured to set the range specified by the predetermined input information as an image capture range within which the visual sensor captures an image, wherein the image capture range setting unit transmits, to the visual sensor, a signal instructing the visual sensor to perform image capture in the set image capture range.

13. The controller according to claim 1, wherein the determination unit determines whether an object is placed on an inspection target surface within the specified range.

14. The controller according to claim 13, wherein the determination unit determines whether an object is placed on the inspection target surface, based on a frequency distribution related to distance information of each point in the acquired depth map.

15. The controller according to claim 14, further comprising a threshold value setting unit configured to set a threshold value for distinguishing between distance information of the inspection target surface in the frequency distribution and distance information of another object on the inspection target surface, wherein the determination unit determines whether an object is placed on the inspection target surface by using the threshold value.

16. The controller according to claim 15, wherein the threshold value setting unit sets the threshold value, based on a frequency distribution related to distance information of each point in a depth map acquired in a situation in which no object is placed on the inspection target surface.

17. The controller according to claim 15, wherein the threshold value setting unit is configured to provide a user interface accepting setting of the threshold value by a user operation.

18. The controller according to claim 17, wherein the user interface is configured as a graphical user interface including an image representing a frequency distribution of the depth map.

19. The controller according to claim 15, wherein the threshold value setting unit sets the threshold value in accordance with threshold value information described in a robot program.

20. The controller according to claim 14, further comprising a histogram creation unit configured to generate an image representing the frequency distribution, based on distance information of each point in the acquired depth map, and display the image on a display screen.

21. The controller according to claim 20, wherein the histogram creation unit is configured to generate an image representing the frequency distribution within a specified range in the depth map.

22. The controller according to claim 14, further comprising a workpiece transfer execution unit configured to execute workpiece transfer work of picking up a workpiece from a feeding device and placing the workpiece on a predetermined placement surface by a robot, wherein the determination unit determines whether an object is present on the placement surface, based on a depth map in which the placement surface is captured before the workpiece transfer execution unit places the workpiece on the placement surface.

23. The controller according to claim 14, further comprising a workpiece pickup execution unit configured to execute pickup work of a robot picking up one or more workpieces loaded in bulk in a container, wherein, when the workpiece pickup execution unit makes a completion determination on pickup of one or more workpieces, based on a predetermined completion determination condition, the determination unit determines whether an object is present on a bottom surface of the container, based on a depth map in which a bottom surface of the container is captured.

24. The controller according to claim 22, further comprising a history image storage unit configured to store a history image when an object is determined to be present by the determination unit.

25. The controller according to claim 14, wherein the depth map is an image representing the distance information of each point by brightness, and the frequency distribution represents a distribution of brightness of each point in the depth map.

26. A robot system comprising:
a robot;
a visual sensor; and
the controller according to claim 1, wherein the controller controls the robot.

27. An object presence determination method executed on an information processing device, the method comprising:
acquiring a depth map captured by a visual sensor; and
determining whether an object is placed within a range specified by predetermined input information, based on the depth map.

28. A non-transitory computer readable storage medium storing instructions that, when executed by a processor of a computer, cause the processor to perform:
acquiring a depth map captured by a visual sensor; and
determining whether an object is placed within a range specified by predetermined input information, based on the depth map.
